(19) United States
(12) Patent Application Publication
(10) Pub. No.: US 2024/0402714 A1
(43) Pub. Date: Dec. 5, 2024

(54) REMOTE ASSISTANCE SYSTEM, REMOTE ASSISTANCE METHOD, AND REMOTE ASSISTANCE PROGRAM

(71) Applicant: DENSO CORPORATION, Kariya-city (JP)

(72) Inventors: HIDEAKI MISAWA, Kariya-city (JP); YASUHIRO HIRAYAMA, Kariya-city (JP)

(21) Appl. No.: 18/805,096

(22) Filed: Aug. 14, 2024

Related U.S. Application Data
(63) Continuation of application No. PCT/JP2023/001364, filed on Jan. 18, 2023.

(30) Foreign Application Priority Data
Feb. 16, 2022 (JP) 2022-022442

(51) Int. Cl. G05D 1/222; G05D 1/646; G05D 109/10

(52) U.S. Cl. CPC G05D 1/222; G05D 1/646; G05D 2109/10

(57) ABSTRACT

By a remote assistance system, a remote assistance method, or a non-transitory tangible storage medium storing a remote assistance program, an assistance request is acquired from a mobile object, instruction information is generated according to an instruction from an operator, the instruction information is transmitted to the mobile object, and evaluation information that has evaluated the operator is output.

### CROSS REFERENCE TO RELATED APPLICATIONS

The present application is a continuation application of International Patent Application No. PCT/JP2023/001364 filed on Jan. 18, 2023, which designated the U.S. and claims the benefit of priority from Japanese Patent Application No. 2022-022442 filed on Feb. 16, 2022. The entire disclosures of all of the above applications are incorporated herein by reference.

### TECHNICAL FIELD

The present disclosure relates to a remote assistance technology that remotely assists automated driving of a mobile object.

### BACKGROUND

A remote assistance technology of a comparative example evaluates a performance of an operator who remotely assists the automated driving of a mobile object and stores evaluation results.

### SUMMARY

By a remote assistance system, a remote assistance method, or a non-transitory tangible storage medium storing a remote assistance program, an assistance request is acquired from a mobile object, instruction information is generated according to an instruction from an operator, the instruction information is transmitted to the mobile object, and evaluation information that has evaluated the operator is output.

### BRIEF DESCRIPTION OF THE DRAWINGS

FIG. 1 is a block diagram showing an overall configuration of an assistance system and a control system according to an embodiment.

FIG. 2 is a block diagram showing a functional configuration of the control system according to the embodiment.

FIG. 3 is a block diagram showing a functional configuration of the assistance system according to the embodiment.

FIG. 4 is a flowchart showing a real-time assistance flow according to the embodiment.

FIG. 5 is a schematic diagram for illustrating a real-time assistance flow according to the embodiment.

FIG. 6 is a flowchart showing an evaluation assistance flow according to the embodiment.

FIG. 7 is a schematic diagram for illustrating the evaluation assistance flow according to the embodiment.

FIG. 8 is a schematic diagram for illustrating the evaluation assistance flow according to the embodiment.

FIG. 9 is a schematic diagram for illustrating the evaluation assistance flow according to the embodiment.

FIG. 10 is a schematic diagram for illustrating the evaluation assistance flow according to the embodiment.

FIG. 11 is a schematic diagram for illustrating the evaluation assistance flow according to the embodiment.

FIG. 12 is a schematic diagram for illustrating the evaluation assistance flow according to the embodiment.

FIG. 13 is a schematic diagram for illustrating the evaluation assistance flow according to the embodiment.

FIG. 14 is a schematic diagram for illustrating the evaluation assistance flow according to the embodiment.

FIG. 15 is a schematic diagram for illustrating the evaluation assistance flow according to the embodiment.

FIG. 16 is a schematic diagram for illustrating the evaluation assistance flow according to the embodiment.

FIG. 17 is a schematic diagram for illustrating the evaluation assistance flow according to the embodiment.

### DETAILED DESCRIPTION

In the comparative example, the performance of the operator is evaluated based on response time and processing time overrun. However, short response times and short processing times do not necessarily mean that the operator performance are adequate, and there are concerns about the reliability of the evaluation results. Further, in the technology of the comparative example, the performance of the operator is evaluated based on the state of an oncoming vehicle and an occupant. However, since the state of the oncoming vehicle and the occupant is not information that directly represents a state of the mobile object itself providing remote assistance, there were concerns about the reliability of the evaluation results.

One example of the present disclosure provides a remote assistance system that provides reliability in performance evaluation for an operator who remotely assists automated driving of a mobile object. Another example of the present disclosure provides a remote assistance method that provides the reliability in the performance evaluation for the operator who remotely assists the automated driving of the mobile object. Further, another example of the present disclosure provides a remote assistance program that provides the reliability in the performance evaluation for the operator who remotely assists the automated driving of the mobile object.

According to a first example embodiment of the present disclosure, a remote assistance system remotely assists automated driving of a mobile object, and includes: a processor; and a memory coupled to the processor and storing program instructions that when executed by the processor cause the processor to at least: acquire an assistance request that is a request from the mobile object; generate instruction information according to an instruction from an operator in response to the assistance request; transmit the instruction information to the mobile object; collect determination information representing determination of the mobile object on the instruction information; and output, as a transition timing of a dynamic driving task by the mobile object, evaluation information that has evaluated the operator based on a time gap between an instruction timing represented by the instruction information and a determination timing represented by the determination information.

According to a second example embodiment of the present disclosure, a remote assistance method remotely assists automated driving of a mobile object, and causes a processor to: acquire an assistance request that is a request from the mobile object; generate instruction information according to an instruction from an operator in response to the assistance request; transmit the instruction information to the mobile object; collect determination information representing determination of the mobile object on the instruction information; and output, as a transition timing of a dynamic driving task by the mobile object, evaluation information that has evaluated the operator based on a time gap between an instruction timing represented by the instruction information and a determination timing represented by the determination information.

According to a third example embodiment of the present disclosure, a non-transitory computer-readable storage medium stores a remote assistance program for remotely assisting automated driving of a mobile object, and the program includes instructions causing a processor to: acquire an assistance request that is a request from the mobile object; generate instruction information according to an instruction from an operator in response to the assistance request; transmit the instruction information to the mobile object; collect determination information representing determination of the mobile object on the instruction information; and output, as a transition timing of a dynamic driving task by the mobile object, evaluation information that has evaluated the operator based on a time gap between an instruction timing represented by the instruction information and a determination timing represented by the determination information.

According to the first to third example embodiments of the present disclosure, from the mobile object to which the generated instruction information of the operator in response to the assistance request has been transmitted, determination information determined on the instruction information is collected. Therefore, according to the first to third example embodiments, the evaluation information is output as a transition timing of a dynamic driving task by the mobile object, and has evaluated the operator based on a time gap between an instruction timing represented by the instruction information and a determination timing represented by the determination information. According to this, the instruction timing, which reflects the determination performance of the operator, can be appropriately evaluated based on the time gap as a result of comparison with the determination timing, which is the direct determination information of the mobile object. Therefore, it is possible to provide a reliable evaluation of the performance of the operator to remotely assist the automated driving of the mobile object.

According to a fourth example embodiment of the present disclosure, a remote assistance system remotely assists automated driving of a mobile object, and includes: a processor; and a memory coupled to the processor and storing program instructions that when executed by the processor cause the processor to at least: acquire an assistance request that is a request from the mobile object; generate instruction information according to an instruction from an operator in response to the assistance request; transmit the instruction information to the mobile object; collect plan information representing a plan provided by the mobile object according to the instruction information; collect behavior information that appears in the mobile object after the plan according to the instruction information; and output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.

According to a fifth example embodiment of the present disclosure, a remote assistance method remotely assists automated driving of a mobile object, and causes a processor to: acquire an assistance request that is a request from the mobile object; generate instruction information according to an instruction from an operator in response to the assistance request; transmit the instruction information to the mobile object; collect plan information representing a plan provided by the mobile object according to the instruction information; collect behavior information that appears in the mobile object after the plan according to the instruction information; and output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.

According to a sixth example embodiment of the present disclosure, a non-transitory computer-readable storage medium stores a remote assistance program for remotely assisting automated driving of a mobile object, and the program includes instructions causing a processor to: acquire an assistance request that is a request from the mobile object; generate instruction information according to an instruction from an operator in response to the assistance request; transmit the instruction information to the mobile object; collect plan information representing a plan provided by the mobile object according to the instruction information; collect behavior information that appears in the mobile object after the plan according to the instruction information; and output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.

In such a manner, according to the fourth to sixth example embodiments of the present disclosure, the behavior information is collected from the mobile object to which the generated instruction information Io of the operator in response to the assistance request has been transmitted. The behavior information is information after the plan according to the plan information planned for the instruction information and the instruction information. Therefore, according to the fourth to sixth example embodiments, evaluation information is output, and has evaluated the operator based on a trajectory gap between a plan trajectory represented by the plan information and an actual trajectory represented by the behavior information, wherein the plan trajectory and the actual trajectory are a traveling trajectory of the mobile object. Thereby, the instruction content reflecting the determination performance of the operator is appropriately evaluated based on the trajectory gap that is the comparison result of the plan trajectory according to the information content with the actual trajectory that is the direct behavior information of the mobile object. Therefore, it is possible to provide a reliable evaluation of the performance of the operator to remotely assist the automated driving of the mobile object.

Hereinafter, an embodiment of the present disclosure will be described with reference to the drawings.

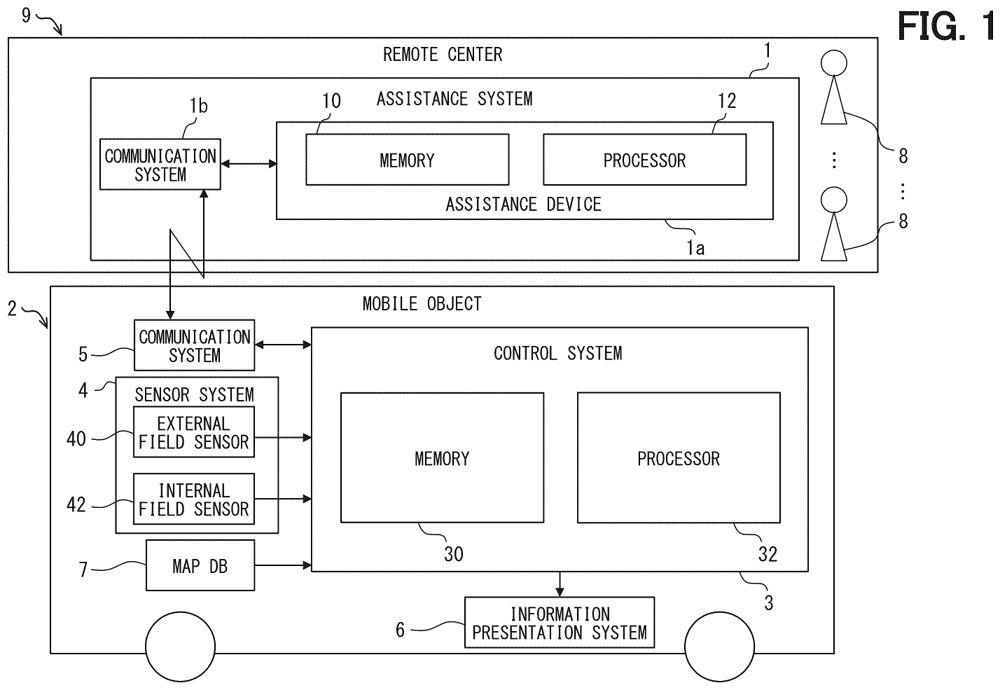

Δn assistance system 1 of the embodiment shown in FIG. 1 is a management system for a mobile object 2 that can be operated by a plurality of operators 8 at a remote center 9. The assistance system 1 is constructed so as to be capable of remotely assisting the automated driving of a plurality of mobile objects 2.

The automated driving of the mobile object 2 is controlled by a control system 3 of the embodiment while receiving remote assistance from the assistance system 1. Here, the mobile object 2 is at least one of a car, a bus, a truck, and the like, which is capable of traveling on a road with an occupant on board. In such a mobile object 2, the automated driving control is implemented so that the control is classified into levels according to the degree of manual intervention by the occupant in the driving task. The automated driving control may be implemented by autonomous traveling control in which the system at the time of operation executes all driving tasks, such as conditional driving automation, advanced driving automation, or complete driving automation. The automated driving control may be implemented by advanced driving assistance control in which an occupant executes some or all driving tasks, such as driving assistance or partial driving automation. The automated driving control may be implemented by either one, combination, or switching between autonomous traveling control and advanced driving assistance control.

The mobile object 2 is equipped with a sensor system 4, a communication system 5, an information presentation system 6, and a map database 7. The sensor system 4 obtains sensor information that can be used by the control system 3 by detecting the external and internal fields of the mobile object 2. For this purpose, the sensor system 4 includes an external field sensor 40 and an internal field sensor 42.

The external field sensor 40 acquires external information as sensor information from the external field that is the peripheral environment of the mobile object 2. The external field sensor 40 may obtain external information by detecting a target present in the external field of the mobile object 2. The external field sensor 40, which detects an object, may be provided by at least one of a camera, a Light Detection and Ranging/Laser Imaging Detection and Ranging (LiDAR), a radar, a sonar, or the like.

The internal field sensor 42 acquires internal information as sensor information from the internal field, which is the internal environment of the mobile object 2. The internal field sensor 42 may acquire internal field information by detecting a specific physical quantity of motion in the internal field of the mobile object 2. The internal field sensor 42 of a physical quantity detection type is at least one type out of, for example, a traveling speed sensor, an acceleration sensor, a gyro sensor, and the like. The internal field sensor 42 may acquire the internal field information by detecting a specific state of the occupant in the internal field of the mobile object 2. The internal field sensor 42 of an occupant detection type is, for example, at least one type out of a Driver Status Monitor (registered trademark), a biological sensor, a seating sensor, an actuator sensor, a vehicle interior apparatus sensor, and the like.

The communication system 5 obtains communication information usable by the control system 3 via wireless communication. The communication system 5 may receive a positioning signal from an artificial satellite of a global navigation satellite system (GNSS) present in the external field of the mobile object 2. For example, the communication system 5 having the positioning function may be a GNSS receiver or the like. The communication system 5 may transmit and receive a communication signal to and from a V2X system present in the external field of the mobile object 2. The communication system 5 of the V2X type may be at least one of, for example, a dedicated short range communications (DSRC) communication device, a cellular V2X (C-V2X) communication device, or the like. The communication system 5 may transmit and receive a communication signal to and from a terminal present in the internal field of the mobile object 2. For example, the communication system 5 having the terminal communication type may be at least one of a Bluetooth (registered trademark) device, a Wi-Fi (registered trademark) device, an infrared communication device, or the like. The information presentation system 6 presents notification information to the occupant inside the mobile object 2. The information presentation system 6 may present notification information by stimulating the occupant's vision. The visual stimulation type information presentation system 6 is at least one type of, for example, a head-up display (i.e., HUD), a multi function display (i.e., MFD), a combination meter, a navigation unit, a light emitting unit, and the like. The information presentation system 6 may present notification information by stimulating the occupant's auditory. The auditory stimulation type information presentation system 6 is, for example, at least one of a speaker, a buzzer, a vibration unit, and the like.

The map database 7 stores map information usable by the control system 3. The map database 7 includes a non-transitory tangible storage medium, which is at least one type of a semiconductor memory, a magnetic medium, an optical medium, or the like. The map database 7 may be a database of locators that estimate the self-state quantity including the self-location of the mobile object 2. The map database 7 may be a database of a navigation unit that navigates the traveling route of the mobile object 2. The map database 7 may be configured by combining a plurality of types of these databases.

The map database 7 acquires and stores the latest map information by, for example, communication with the remote center 9 via the V2X type communication system 5. The map information is a two or three-dimensional data indicating a traveling environment of the mobile object 2. In particular, digital data of a high-precision map is advisable to be adopted as the three-dimensional map information. The map information may include road information indicating at least one type out of, for example, a location, a shape, a road surface condition, and the like of the road itself. The map information may include marking information, which indicates at least one of traffic sign attached to a road, lane mark position, or lane mark shape. The map information may include structure information indicating at least one of positions and shapes of a building and a traffic light along a road.

The control system 3 includes at least one dedicated computer. The dedicated computer configuring the control system 3 is connected to the sensor system 4, the communication system 5, the information presentation system 6, and the map database 7 via at least one of, for example, a local area network (LAN) line, a wire harness, an internal bus, or a wireless communication line.

The dedicated computer configuring the control system 3 may be an integrated electronic control unit (ECU) that integrates driving control of the mobile object 2. The dedicated computer configuring the control system 3 may be a determination ECU that determines driving tasks in the driving control of the mobile object 2. The dedicated computer configuring the control system 3 may be a monitoring ECU that monitors the driving control of the mobile object 2. The dedicated computer configuring the control system 3 may be an evaluation ECU that evaluates the driving control of the mobile object 2.

The dedicated computer configuring the control system 3 may be a navigation ECU that navigates the traveling route of the mobile object 2. The dedicated computer constituting the control system 3 may be a locator ECU that estimates a self-state quantity of the mobile object 2. The dedicated computer configuring the control system 3 may be an actuator ECU that controls the travel actuator of the mobile object 2. The dedicated computer configuring the control system 3 may be an HCU (i.e, Human Machine Interface Control Unit or HMI Control Unit) that controls information presentation by the information presentation system 6 in the mobile object 2. The dedicated computer configuring the control system 3 may be, for example, a computer outside the mobile object 2. For example, the dedicated computer may be a computer that configures a mobile terminal, or the like capable of communicating via the V2X type communication system 5.

The dedicated computer configuring the control system 3 includes at least one memory 30 and at least one processor 32. The memory 30 is at least one type of a non-transitory tangible storage medium of, for example, a semiconductor memory, a magnetic medium, and an optical medium, for non-transitory storage of computer readable programs, data, and the like. For example, the processor 32 may include, as a core, at least one of a central processing unit (CPU), a graphics processing unit (GPU), a reduced instruction set computer (RISC) CPU, a data flow processor (DFP), a graph streaming processor (GSP), or the like.

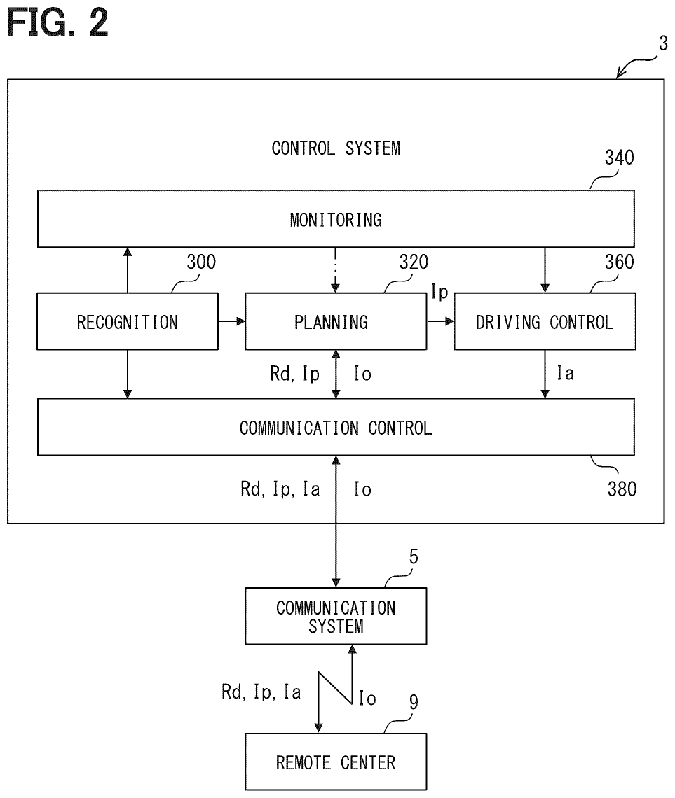

In the control system 3, the processor 32 performs a plurality of instructions contained in a control program stored in the memory 30 in order to perform automated driving control of the mobile object 2. Thereby, the control system 3 constructs a plurality of functional blocks for performing automated driving control of the mobile object 2. The plurality of function blocks constructed in the control system 3 include a recognition block 300, a planning block 320, a monitoring block 340, a driving control block 360, and a communication control block 380, as shown in FIG. 2.

The recognition block 300 acquires sensor information from the external field sensor 40 and the internal field sensor 42 of the sensor system 4. The recognition block 300 acquires communication information from the communication system 5. The recognition block 300 obtains map information from the memory 30. The recognition block 300 fuses these acquired information as inputs to determine the interior and exterior environments of the mobile object 2 and recognize the traveling scene.

Specifically, the recognition block 300 recognizes objects in the external field of the mobile object 2, including other road users, obstacles, and structures. At this time, the recognition block 300 may further recognize at least one type of distance, relative speed, relative acceleration, and attributes regarding the recognition object. The recognition block 300 recognizes the current and future travel paths of the mobile object 2. At this time, the recognition block 300 may further recognize a recognition traveling route state of at least one type of the road surface, lanes, road edges, free space, traffic lights, or markings.

The recognition block 300 estimates the self-state quantities including the self-position of the mobile object 2 by localization. At this time, the recognition block 300 may update map information relating to the traveling route of the mobile object 2 at the same time as recognizing the self-state quantity, and feed back the update result to the map database 7. The recognition block 300 recognizes the time of each traveling scene of the mobile object 2. At this time, the recognition block 300 may output time information relating to the recognized time in association with other recognition results.

The planning block 320 obtains recognition information representing the recognition result from the recognition block 300. The recognition block 300 acquires communication information including instruction information Io from the remote center 9 via the communication system 5. The planning block 320 chronologically plans a future route, future trajectory, and dynamic driving task (DDT) for future actions of the mobile object 2, as well as future transitions of interactions between the mobile object 2 and other road users, by determining them for each traveling scene based on the acquired recognition information and instruction information Io. Then, the planning block 320 may perform determination and planning using a vehicle traveling model, such as a simulation model or a machine learning model. Here, the DDT of the planning object may be defined as the real-time operational and tactical functions for operating the mobile object 2 in traffic, or as all real-time operational and tactical functions required to operate the mobile object 2 in road traffic.

Specifically, in a traveling scene where an assistance request Rd to the remote center 9 has not been generated, the planning block 320 performs the plan without waiting for the instruction information Io from the remote center 9. However, at this time, in an unreasonable situation where it is determined that an unreasonable risk exists, the planning block 320 generates the assistance request Rd requesting assistance by the operator 8 at the remote center 9, and passes it to the communication control block 380 to be transmitted from the communication system 5 to the remote center 9. Here, the assistance request Rd includes at least request information regarding the transition necessity, the type of destination DDT, and the transition timing determination, for transitioning the mobile object 2 from the current DDT to another future DDT.

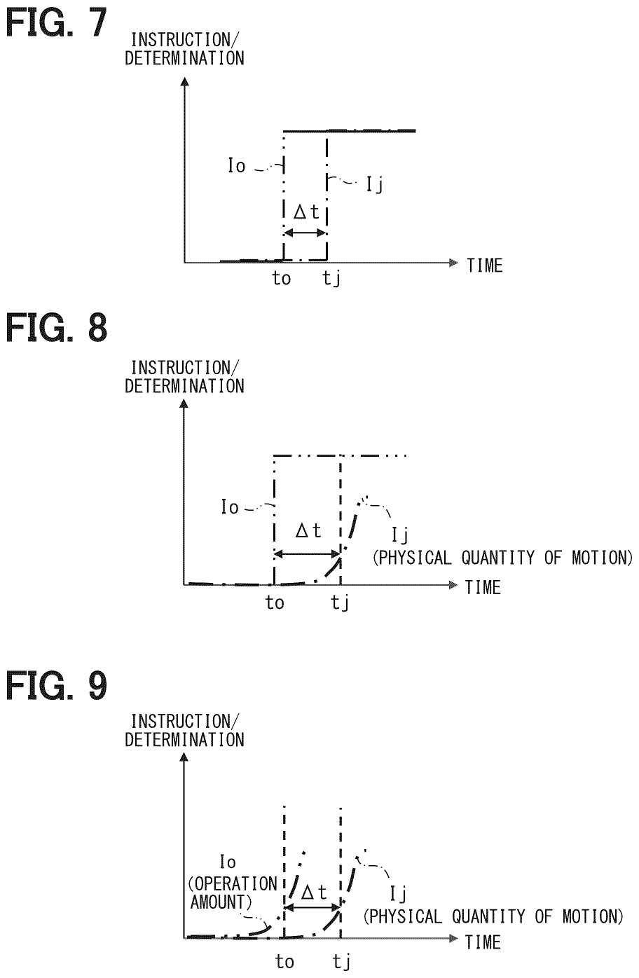

Therefore, in the traveling scene where the assistance request Rd to the remote center 9 has been generated, the planning block 320 waits for instruction information Io from the remote center 9 before performing the plan. At this time, the planning block 320 determines whether the mobile object 2 can transition to the DDT indicated by the instruction information Io. As a result, when a positive determination is made regarding the transition, the planning block 320 performs the plan to implement the transition to the DDT at the instruction timing to (see FIGS. 7 to 9 described later), which is the transition timing of the mobile object 2 to the DDT represented by the instruction information Io. On the other hand, when the planning block 320 makes a negative determination to transition, it performs the plan to implement the transition to DDT based on its own determination by rejecting at least the instruction timing to of the instruction information Io.

The monitoring block 340 acquires the recognition information from the recognition block 300. Based on the acquired recognition information, the monitoring block 340 monitors the risk between the mobile object 2 and other road users in chronological order in a manner separate from the determination made by the planning block 320.

Specifically, the monitoring block 340 sets a safety envelope in consideration of, for example, a vehicle level safety strategy or the like, based on recognition information for each acquired traveling scene. The safety envelope may be defined as a set of limitations and conditions under which the system is designed to act as a target of a constraint/restriction or control to maintain operation of the mobile object 2 within an acceptable level of risk. Such a safety envelope may be defined as a physical-based margin around each road user including the mobile object 2 and the other road users. The safety envelope may be set with a margin relating to at least one physical quantity such as a distance, velocity, or acceleration.

The monitoring block 340 performs a safety determination between the mobile object 2 and other road users based on the set safety envelope and the acquired recognition information for each traveling scene. That is, the monitoring block 340 implements the safety determination by testing whether there is a violation of the safety envelope in a traveling scene interpreted based on recognition information between the mobile object 2 and other road users. When the monitoring block 340 determines that the safety envelope has been violated, it sets appropriate actions to be taken for each state transition of the mobile object 2 as an appropriate response, as constraints on the mobile object 2. Here, the constraint may be a functional restriction or a degraded constraint. The driving control block 360 acquires plan information Ip representing the plan results from the planning block 320. The driving control block 360 controls the automated driving of the mobile object 2 so as to implement the DDT according to the acquired plan information Ip. At this time, the driving control block 360 gives control instructions to the plurality of traveling actuators that cause the mobile object 2 to behave in accordance with the plan information Ip, the control instructions being determined to implement the behavior of the mobile object 2 according to the plan information Ip.

Specifically, the driving control block 360 obtains determination information regarding the safety envelope from the monitoring block 340. When the driving control block 360 obtains determination information indicating no violation of the safety envelope, it implements DDT in accordance with the plan information Ip in the automated driving control of the mobile object 2 without any constraints. On the other hand, when the driving control block 360 acquires determination information indicating the violation of the safety envelope, it imposes the constrain on the DDT in the automated driving control of the mobile object 2 based on the determination information. At this time, the driving control block 360 may perform a constraint process on the automated driving control by restricting the control instruction.

Here, acquisition of the determination information from the monitoring block 340 may be performed by the planning block 320 instead of the driving control block 360. At this time, when the planning block 320 obtains information indicating that the safety envelope has not been violated, it performs the plan as described above. On the other hand, when the planning block 320 obtains determination information indicating the violation of the safety envelope, it imposes constraints based on the determination information regarding the safety envelope on the DDT in the planning stage prior to the control stage, without requesting the assistance Rd from the remote center 9.

The communication control block 380 acquires the recognition information from the recognition block 300. The communication control block 380 obtains the assistance request Rd and the plan information Ip from the planning block 320. The communication control block 380 acquires, from the driving control block 360, control instruction information representing the control instruction, as well as behavior information Ia representing an actual behavior Ba exhibited by the mobile object 2 as a control result in response to the control instruction. The communication control block 380 controls the transmission of such acquired information to the remote center 9 via the communication system 5. At the same time, the communication control block 380 controls the reception of instruction information Io from the remote center 9 by the communication system 5.

As shown in FIG. 1, the assistance system 1 installed in the remote center 9 includes an assistance device 1a and a communication system 1b, and mainly includes at least one of a cloud server or an edge server, for example. The communication system 1b forms at least a part of a V2X system capable of communicating with the communication system 5 of each mobile object 2. The assistance device 1a is connected to the communication system 1b via at least one of a wired communication line and a wireless communication line. The assistance device 1a includes at least one dedicated computer. In the assistance device 1a, an output control process is executed so that information acquired from each mobile object 2 that can communicate through the communication system 1b is displayed and output to the operator 8 in the remote center 9. In the assistance device 1a, an input control process is executed so as to receive, from the operator 8, instruction information Io (see FIG. 2) that is fed back to each mobile object 2 with which communication is possible via the communication system 1b.

The dedicated computer configuring the assistance device 1a has at least one memory 10 and at least one processor 12. The memory 10 is at least one type of non-transitory tangible storage medium of, for example, a semiconductor memory, a magnetic medium, and an optical medium, for non-transitory storage of computer readable programs, data, and the like. The processor 12 includes at least one of the CPU, GPU, and RISC-CPU as a core.

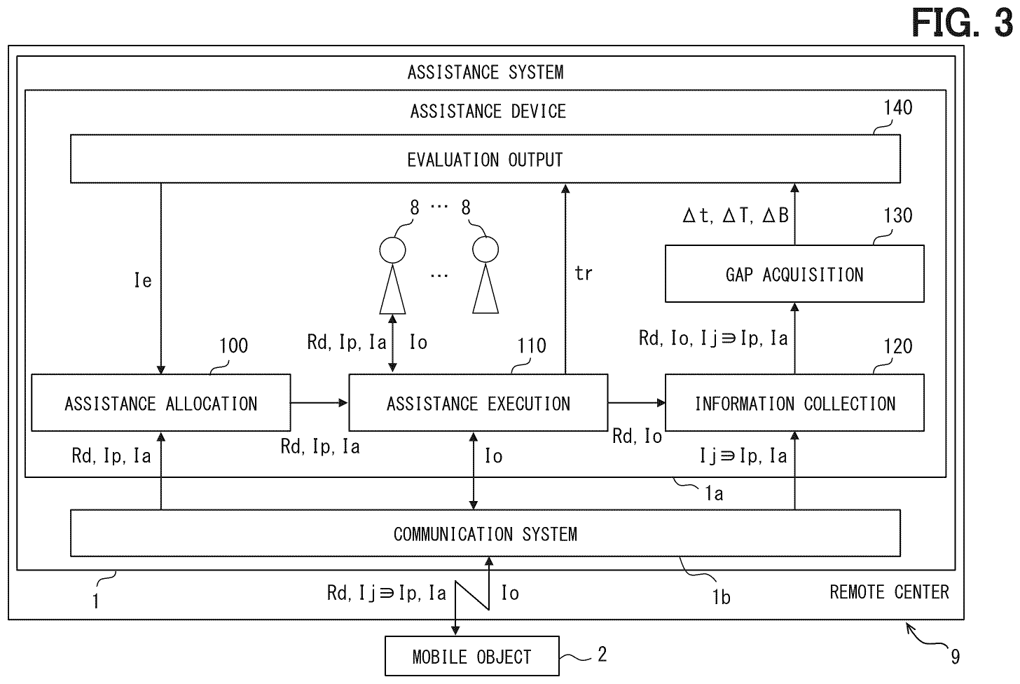

In the assistance device 1a, the processor 12 executes a plurality of instructions contained in a remote assistance program stored in the memory 10 to perform a remote assistance method for remotely assisting the automated driving of the mobile object 2 by the assistance system 1. At this time, the instructions of the remote assistance program are executed in cooperation with the instructions of the control program in the control system 3. As a result, the assistance device 1a constructs a plurality of functional blocks for performing the remote assistance method for the mobile object 2 by the assistance system 1. The plurality of functional blocks constructed in the assistance device 1a include an assistance allocation block 100, an assistance execution block 110, an information collection block 120, a gap acquisition block 130, and an evaluation output block 140, as shown in FIG. 3.

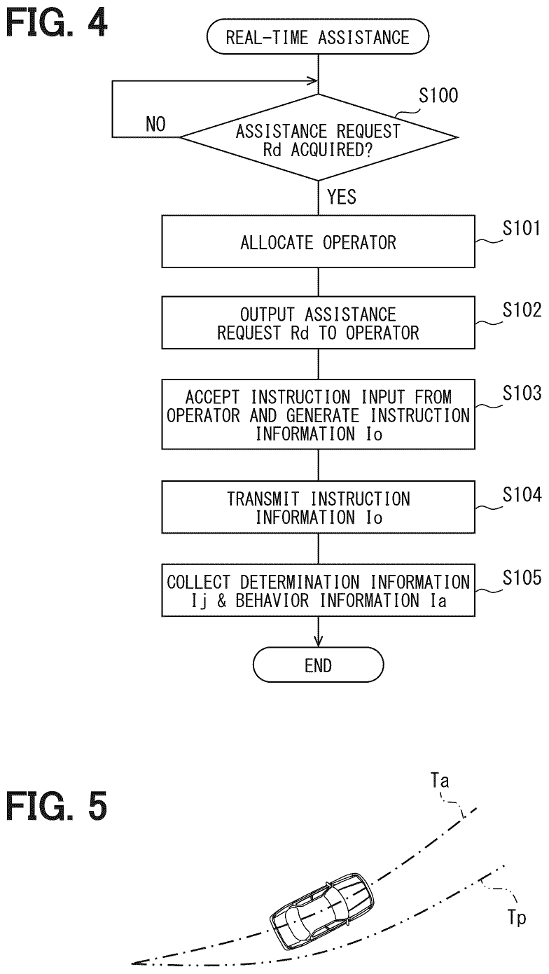

In the assistance device 1a, the processor 12 executes the remote assistance method for the mobile object 2 by constructing these blocks 100, 110, 120, 130, and 140. Among these remote assistance methods, a real-time assistance method that provides real-time assistance to the automated driving of the mobile object 2 is executed according to the real-time assistance flow shown in FIG. 4. Each “S” in the real-time assistance flow represents a plurality of steps executed by a plurality of commands included in the remote assistance program.

In S100, the assistance allocation block 100 in FIG. 3 determines whether the assistance request Rd from any of the mobile objects 2 has been received through the communication system 1b. As a result, when it is determined that the assistance request Rd has been acquired, the real-time assistance flow proceeds to S101 as shown in FIG. 4.

In S101, the assistance allocation block 100 in FIG. 3 allocates the operator 8 to assist the mobile object 2 that has issued the assistance request Rd, based on the acquired assistance request Rd. At this time, the assistance allocation block 100 determines the priority of the assistance request Rd relative to other assistance requests Rd based on at least one type of the recognition information, planning information Ip, control instruction information, and behavior information Ia obtained together with the assistance request Rd from the assistance destination mobile object 2 via the communication system 1b. Further, the assistance allocation block 100 selects operators 8 that meet the determined priority based on the operating status of each operator 8 and the evaluation information Ie for each operator 8, which will be described later. At this time, the assistance allocation block 100 may receive an input of an allocation instruction from a management operator who manages other operators 8 out of all the operators 8 by making a request for allocation assistance to the management operator.

As shown in FIG. 4, in the next S102, the assistance execution block 110 in FIG. 3 outputs the assistance request Rd to the operator 8 allocated to the assistance request Rd. At this time, the assistance execution block 110 outputs, to the allocated operator 8, at least one type of the recognition information, the plan information Ip, the control instruction information, and the behavior information Ia acquired together with the assistance request Rd by the assistance allocation block 100 in S101.

As shown in FIG. 4, in the next S103, the assistance execution block 110 in FIG. 3 receives an input of an instruction to the assistance destination mobile object 2 as a result of determination on the assistance request Rd from the operator 8 allocated to the assistance request Rd. At this time, the instruction information Io generated according to input from the operator 8 includes instruction information regarding at least the contents determined regarding the instruction timing among whether the transition is necessary, the type of destination DDT, and the instruction timing to as the transition timing, for transitioning the assisted mobile object 2 from the current DDT to another future DDT (see FIGS. 7 to 9 described below). Here, an example of the type of the transition destination DDT is a departure task of the mobile object 2 that has stopped at an intersection, a stopping position, or the like, and in this case, an example of the instruction timing to is the timing of transition to a departure task. In particular, in the present embodiment, the instruction indicating the instruction information Io may be provided by the operator 8 inputting an instruction by remotely operating the mobile object 2 from a remote cockpit in the remote center 9, for example.

In S103, the instruction information Io generated as described above is stored in the memory 10 in association with the assistance request Rd. In particular, in S103 of the present embodiment, the response time tr (see FIG. 13 described later) from the allocation of the operator 8 to the reception of the input of an instruction is accumulated by being stored in the memory 10 in association with the assistance request Rd and the instruction information Io.

As shown in FIG. 4, in the next S104, the assistance execution block 110 in FIG. 3 transmits instruction information Io generated in accordance with an input from the operator 8 allocated to the assistance request Rd to the mobile object 2 that is the assistance destination via the communication system 1b. Therefore, in the previous S103, the instruction information Io is generated so that it can be transmitted to the mobile object 2 that is the assistance destination in the subsequent S104.

As shown in FIG. 4, in the next S105, the information collection block 120 of FIG. 3 collects, through the communication system 1b, the recognition information, the plan information Ip, and the control command information of the assistance destination mobile object 2 that received the instruction information Io, as determination information Ij that is a post-determination made by the mobile object 2 in response to the instruction information Io. That is, after planning for the instruction information Io, the information collection block 120 collects the determination information Ij including the plan information Ip from the assistance destination mobile object 2. At the same time, in S105, the information collection block 120 collects, via the communication system 1b, behavior information Ia of the assistance destination mobile object 2 that has received the instruction information Io.

Here, in S105, collection of determination information Ij and behavior information Ia continues for a period from the transmission of instruction information Io in S104 until a set time including a determination timing tj (see FIGS. 7 to 9 described below), which is the transition timing of the DDT determined in the mobile object 2, has elapsed. During such a collection duration period, it is assumed that constraints are imposed by the driving control block 360 or the planning block 320 after the assistance destination mobile object 2 plans the plan information Ip for the instruction information Io. In particular, the information collection block 120 of the present embodiment is capable of collecting planning information Ip representing a planned trajectory Tp planned for the instruction information Io as shown in FIG. 5, and behavior information la representing an actual trajectory Ta given constraints for the planned trajectory Tp as shown in the same figure.

As shown in FIG. 4, in S105, the thus collected determination information Ij and behavior information Ia are stored in the memory 10 in association with the assistance request Rd and instruction information Io, and are accumulated. Based on the above, one real-time assistance flow ends. During execution of a real-time assistance flow, in preparation for another assistance request Rd, a different real-time assistance flow may start in parallel with S101 and subsequent processes of the current execution.

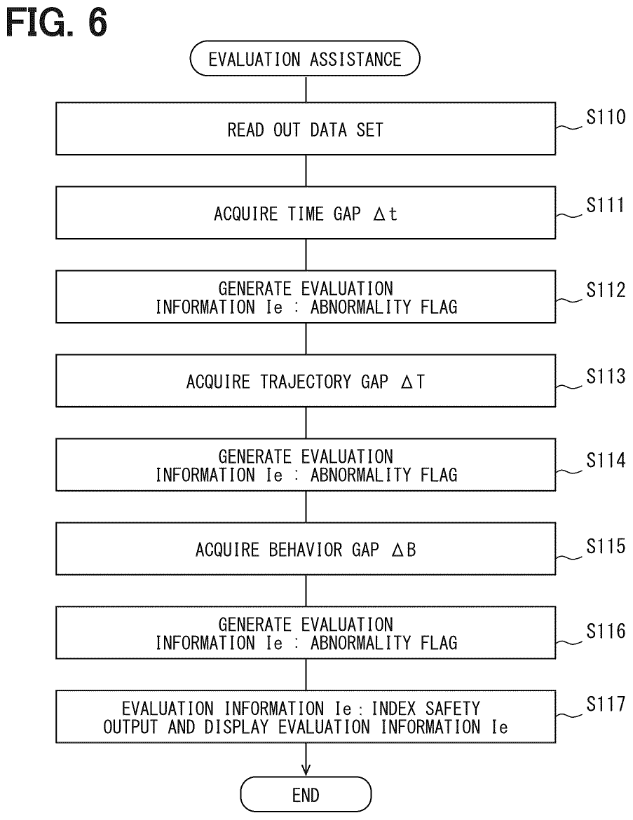

Among the remote assistance methods for the mobile object 2, the evaluation assistance method for assisting the evaluation of each operator 8 is executed according to an evaluation assistance flow shown in FIG. 6. Each “S” in the evaluation assistance flow also represents a plurality of processes executed by a plurality of instructions included in the remote assistance program.

In S110, the gap acquisition block 130 in FIG. 3 reads out a data set of the assistance request Rd, the instruction information Io, the determination information Ij including the plan information Ip, and the behavior information Ia stored in the memory 10 in association with each other. The reading out at this time may be performed for each data set upon completion of one real-time assistance session, or may be performed collectively for a plurality of data sets resulting from a plurality of completed real-time assistance sessions. Therefore, the following description of each process will be given as a representative description of the processing for one data set.

As shown in FIG. 6, in the following S111, the gap acquisition block 130 of FIG. 3 acquires the time gap Δt between the instruction timing to represented by the instruction information Io and the determination timing tj represented by the determination information Ij corresponding to the instruction information Io as the transition timing of the DDT by the mobile object 2. At this time, the gap acquisition block 130 calculates the time difference between the instruction timing to and the determination timing tj as a time gap Δt.

Specifically, in S111, as shown in FIGS. 7 and 8, the gap acquisition block 130 may calculate the time gap Δt from the instruction timing to which the instruction information Io directly indicates by time. As shown in FIG. 7, the gap acquisition block 130 may calculate the time gap Δt from the determination timing tj that is directly represented by the determination information Ij in terms of time. As shown in FIGS. 8 and 9, the gap acquisition block 130 may calculate the time gap Δt from the determination timing tj indirectly represented by the determination information Ij based on the physical quantities of motion such as the vehicle speed, steering angle, or acceleration/deceleration of the mobile object 2, for example. As shown in FIG. 9, when the instruction indicating the instruction information Io is provided by the operator 8 by remotely operating the mobile object 2 as input, the gap acquisition block 130 may calculate a time gap Δt from the instruction timing to indirectly represented by the instruction information Io based on the amount of operation of the remote control. Furthermore, when the instruction indicating the instruction information Io is provided by the operator 8 by remote operation, prior determination information Ij preceding the instruction information Io may be acquired by S105 and read out by S110, and the time difference from the prior determination timing tj to the instruction timing to may be calculated as the time gap Δt.

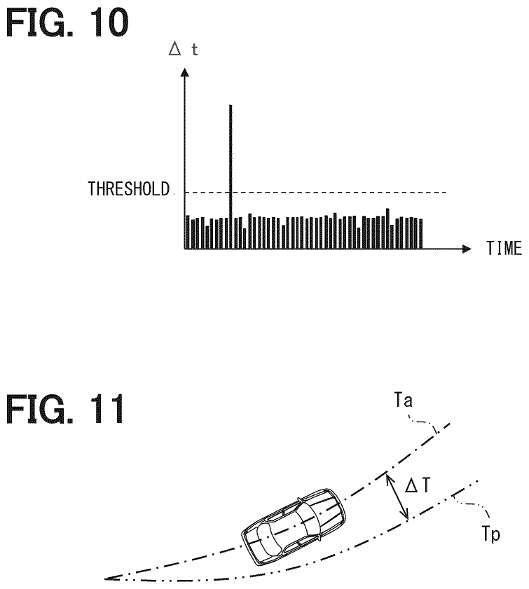

As shown in FIG. 6, in the next S112, the evaluation output block 140 in FIG. 3 generates the evaluation information Ie that evaluates the operator 8 corresponding to the instruction information Io based on the acquired time gap Δt. At this time, the evaluation output block 140 compares the time gap Δt acquired in S111 with a time reference threshold value that is clustered for each type of traveling scene as shown in FIG. 10 and set to, for example, an average value, a median value, or a mode value for the time gap Δt previously stored in the memory 10.

As a result of comparing the time gap Δt with the time reference threshold, in S112 shown in FIG. 6, when the time gap Δt is equal to or exceeds the time reference threshold, the evaluation output block 140 in FIG. 3 determines that the command by the operator 8 was an abnormal determination. In this case, the evaluation output block 140 generates an abnormality flag representing the result of the abnormality determination as evaluation information Ie, and accumulates the evaluation information Ie by storing it in the memory 10 in association with the operator 8 that is the evaluation target.

As shown in FIG. 6, in the next S113, the gap acquisition block 130 in FIG. 3 acquires, as the traveling trajectory of the mobile object 2, a trajectory gap ΔT between the planned trajectory Tp represented by the plan information Ip planned in response to the instruction information Io and the actual trajectory Ta represented by the behavior information Ia that appears after the planning. At this time, as shown in FIG. 11, the gap acquisition block 130 may aggregate the distance between the trajectories Tp and Ta at the same time, or the distance calculated by DTW (Dynamic Time Warping), and extract a representative value, such as the average value or median value, of the aggregated distance as the trajectory gap ΔT. The gap acquisition block 130 may aggregate the attitude angle deviations between the trajectories Tp and Ta at the same time, and extract a representative value, such as an average value or a median value, of the aggregated deviations as the trajectory gap ΔT.

As shown in FIG. 6, in the next S114, the evaluation output block 140 in FIG. 3 generates evaluation information Ie also based on the acquired trajectory gap ΔT. At this time, the evaluation output block 140 compares the trajectory gap ΔT acquired in S113 with a trajectory reference threshold value that is clustered for each type of traveling scene and set to, for example, an average value, a median value, or a mode value for the trajectory gap ΔT previously stored in the memory 10. Here, the comparison of the trajectory gap ΔT with the trajectory reference threshold value is performed regardless of the presence or absence of a constraint on the actual trajectory Ta represented by the behavior information Ia, or only when the constraint is applied to the actual trajectory Ta.

As a result of comparing the trajectory gap Δt with the trajectory threshold, in S114 shown in FIG. 6, when the trajectory gap Δt is equal to or exceeds the trajectory threshold, the evaluation output block 140 in FIG. 3 determines that the command by the operator 8 was an abnormal determination. In this case, the evaluation output block 140 generates an abnormality flag representing the result of the abnormality determination as evaluation information Ie, and accumulates the evaluation information Ie by storing it in the memory 10 in association with the operator 8 that is the evaluation target.

As shown in FIG. 6, in the next S115, the gap acquisition block 130 in FIG. 3 acquires a behavior gap ΔB between an actual behavior Ba of the mobile object 2 represented by the behavior information Ia that appeared after planning for the instruction information Io and a statistical behavior Bs represented by statistical information Is previously accumulated in the memory 10 regarding the actual behavior Ba. Here, the statistical information Is includes information of statistical behavior Bs, which is clustered for each type of traveling scene and set to, for example, an average value, a median value, or a mode value, for the actual behavior Ba previously accumulated in the memory 10.

Therefore, the gap acquisition block 130 in S115 may extract, as the behavior gap ΔB, the difference between the value represented by the statistical behavior Bs and the amount of change over time of a physical quantity of motion, such as vertical acceleration, which represents the actual behavior Ba in the traveling scene in which sudden braking occurs in the mobile object 2 after planning for the instruction information Io. The gap acquisition block 130 may extract, as the behavior gap ΔB, the difference between the value represented by the statistical behavior Bs and the time change in a physical quantity of motion such as vertical acceleration, lateral acceleration, attitude angle, TTC (Time To Collision), or TTV (Time To Vehicle), which represents the actual behavior Ba in a risk avoidance traveling scene that appears in the mobile object 2 after planning for the instruction information Io.

As shown in FIG. 6, in the next S116, the evaluation output block 140 in FIG. 3 generates evaluation information Ie also based on the acquired behavior gap ΔB. At this time, the evaluation output block 140 compares the behavior gap ΔB obtained in S115 with a behavior reference threshold value that determines the boundary between normal determination and abnormal determination.

As a result of comparing the behavior gap ΔB with the behavior reference threshold, in S116 shown in FIG. 6, when the behavior gap ΔB is equal to or exceeds the behavior reference threshold, the evaluation output block 140 in FIG. 3 determines that the command by the operator 8 was an abnormal determination. In this case, the evaluation output block 140 generates an abnormality flag representing the result of the abnormality determination as evaluation information Ie, and accumulates the evaluation information Ie by storing it in the memory 10 in association with the operator 8 that is the evaluation target. The abnormality determination in S116 may be performed by, for example, variance analysis or k-nearest neighbor analysis for the current and past behavior gap ΔB for each operator 8.

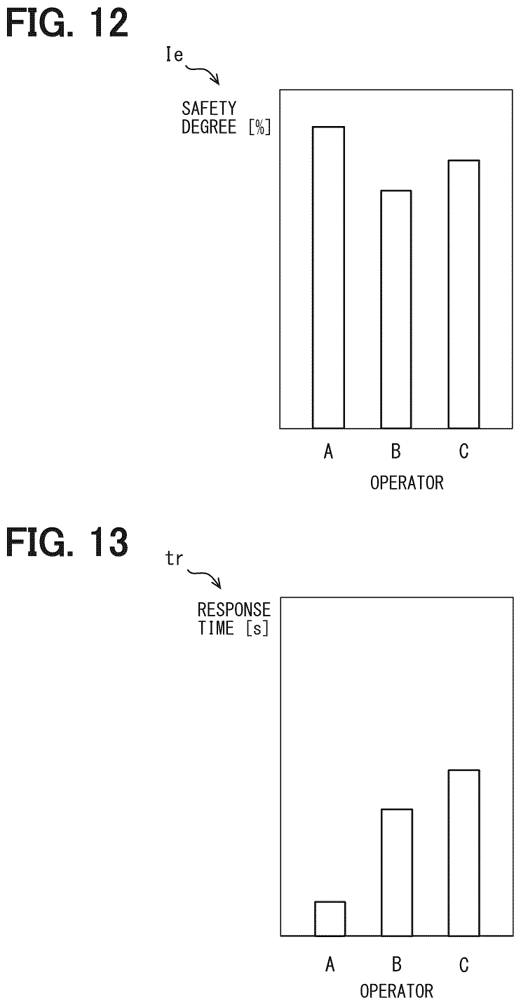

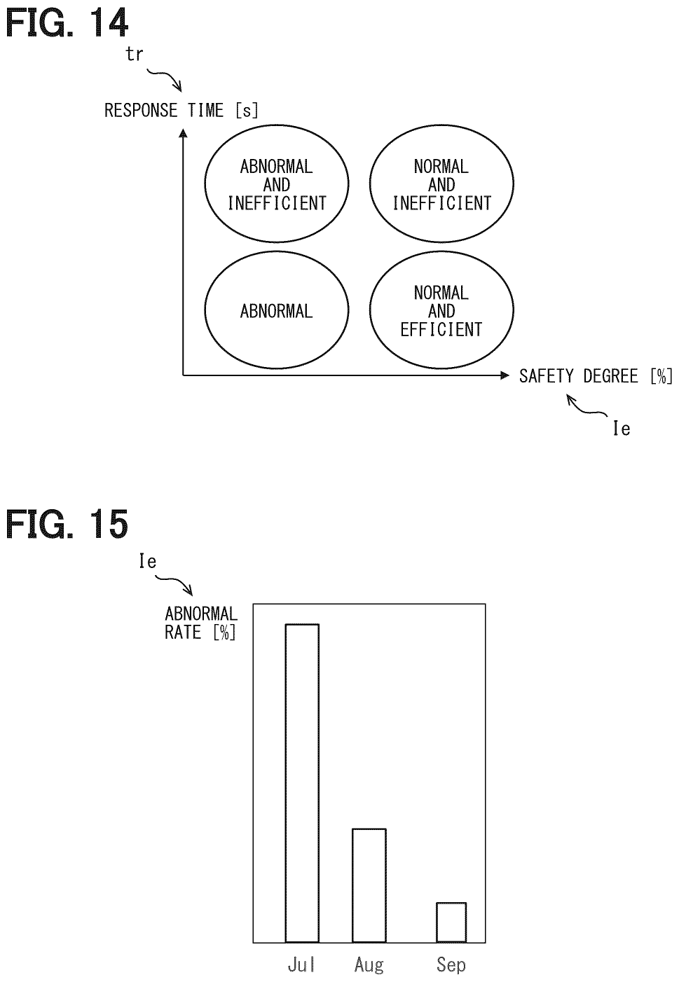

As shown in FIG. 6, in the next S117, the evaluation output block 140 in FIG. 3 outputs, on the display, the evaluation information Ie accumulated in the memory 10 for each operator 8. At this time, before displaying, the evaluation output block 140 extracts the proportion of instruction information Io for which an abnormality flag has been set based on at least one of the gaps Δt, ΔT, or ΔB, and indexes the reciprocal of the extracted proportion as evaluation information Ie for evaluating the safety of the instructions given by each operator 8. Therefore, as shown in FIG. 12, the evaluation output block 140 may compare the indexed safety evaluation information Ie between the operators 8 and display it. As shown in FIG. 13, the evaluation output block 140 may compare representative values, such as the average value, median value, or mode value, of the response times tr accumulated in the memory 10 between the operators 8, and display them. As shown in FIG. 14, the evaluation output block 140 may further analyze the instruction characteristics of each operator 8 as evaluation information Ie based on the indexed safety evaluation information Ie and the response time tr, and display a scatter plot of the analysis results for those operators 8.

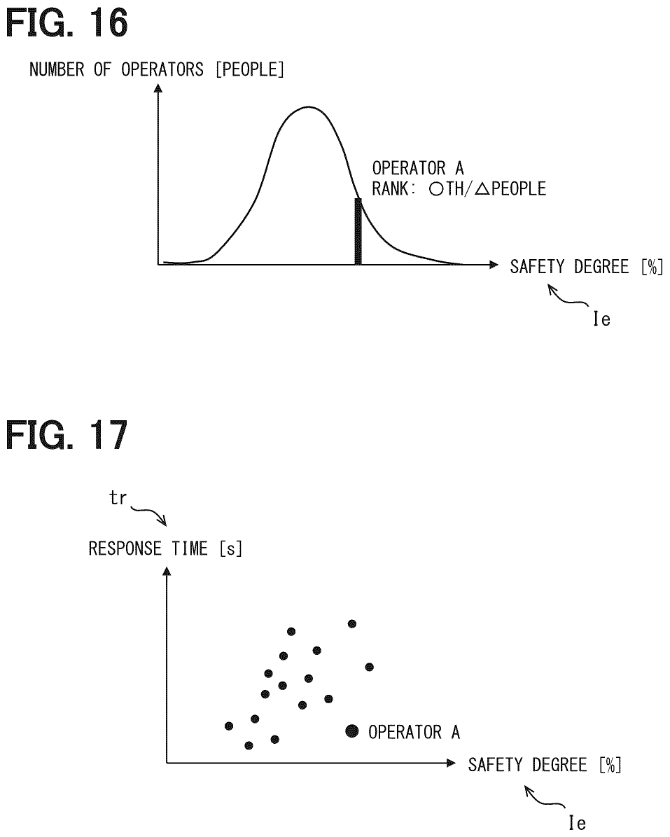

As shown in FIG. 15, the evaluation output block 140 may display, for each operator 8, as evaluation information Ie, the change over time in the abnormality ratio, which is the extraction ratio of instruction information Io for which an abnormality flag has been set. As shown in FIG. 16, the evaluation output block 140 may normalize the indexed safety evaluation information Ie between operators 8 in a set number of units, and display the corresponding points and rankings in the normalized distribution for each operator 8. As shown in FIG. 17, the evaluation output block 140 may display the correlation distribution between the indexed safety evaluation information Ie and the response time tr, as well as the corresponding points for each operator 8 in the correlation distribution.

In this manner, one evaluation assistance flow is completed as shown in FIG. 6. Here, the evaluation information Ie displayed as described above is stored in the memory 10 and accumulated, and is used, for example, for allocation of the operator 8 in a real-time assistance flow.

### Operation and Effects

The operation and effects in the present embodiment described above will be described below.

In the present embodiment, from the mobile object 2 to which the generated instruction information Io of the operator 8 in response to the assistance request Rd has been transmitted, determination information Ij determined on the instruction information Io is collected. Therefore, in the present embodiment, the evaluation information Ie is output as the transition timing of the DDT by the mobile object 2, and evaluates the operator 8 based on the time gap Δt between the instruction timing to represented by the instruction information Io and the determination timing tj represented by the determination information Ij. According to this, the instruction timing to, which reflects the determination performance of the operator 8, can be appropriately evaluated based on the time gap Δt as a result of comparison with the determination timing tj, which is the direct determination information Ij of the mobile object 2. Therefore, it is possible to provide a reliable evaluation of the performance of the operator 8 to remotely assist the automated driving of the mobile object 2.

In the present embodiment, behavior information Ia is collected from the mobile object 2 to which the generated instruction information Io of the operator 8 in response to the assistance request Rd has been transmitted. The behavior information Ia is information after the plan according to the plan information Ip planned for the instruction information Io and the instruction information Io. Therefore, according to the present embodiment, the evaluation information Ie is output, which evaluates the operator 8 based on the trajectory gap ΔT between the plan trajectory Tp represented by the plan information Ip and the actual trajectory Ta represented by the behavior information Ia as the traveling trajectory of the mobile object 2. Thereby, the instruction content reflecting the determination performance of the operator 8 is appropriately evaluated based on the trajectory gap ΔT that is the comparison result of the plan trajectory Tp according to the information content with the actual trajectory Ta that is the direct behavior information Ia of the mobile object 2. Therefore, it is possible to provide a reliable evaluation of the performance of the operator 8 to remotely assist the automated driving of the mobile object 2.

According to the present embodiment, behavior information Ia represents the actual trajectory Ta constrained by the mobile object 2 with respect to the plan information Ip, and is collected. Thereby, the instruction content reflecting the determination performance of the operator 8 is appropriately evaluated based on the trajectory gap ΔT that is the comparison result of the plan trajectory Tp according to the information content with the actual trajectory Ta with the constrain as the direct behavior information Ia of the mobile object 2. Therefore, it is possible to improve the reliability in evaluating the performance of the operator 8 who remotely assists in the automated driving of the mobile object 2.

According to the present embodiment, the evaluation information Ie is output based on the behavior gap ΔB between the actual behavior Ba of the mobile object 2 represented by the behavior information Ia and the statistical behavior Bs represented by the statistical information Is accumulated regarding the actual behavior Ba. According to this, the content of the instructions reflecting the determination performance of the operator 8 can be appropriately evaluated based on the behavior gap ΔB, which is the result of comparing the direct actual behavior Ba of the mobile object 2 with respect to the plan information Ip according to the instruction content and the statistical behavior Bs, which is the statistical information Is of the past actual behavior Ba. Therefore, it is possible to improve the reliability in evaluating the performance of the operator 8 who remotely assists the automated driving of the mobile object 2.

According to the present embodiment, the instruction information Io may be generated based on the instruction from the operator 8 via the remote control of the mobile object 2. In this case, the instruction timing to, which reflects the remote operation performance including the determination performance of the operator 8, can be appropriately evaluated based on the time gap Δt as a result of comparison with the determination timing tj, which is the direct determination information Ij of the mobile object 2. Further, the instruction content reflecting the remote operation performance including the determination performance of the operator 8 is appropriately evaluated based on the trajectory gap ΔT that is the comparison result of the plan trajectory Tp according to the information content with the actual trajectory Ta that is the direct behavior information Ia of the mobile object 2. Furthermore, the content of the instructions reflecting the remote operation performance including the determination performance of the operator 8 can be appropriately evaluated based on the behavior gap ΔB, which is the result of comparing the direct actual behavior Ba of the mobile object 2 with respect to the plan information Ip according to the instruction content and the statistical behavior Bs, which is the statistical information Is of the past actual behavior Ba. According to these, it is possible to provide a reliable evaluation of the performance of the operator 8 who remotely assists the automated driving of the mobile object 2 by remote operation.

### Other Embodiments

Although one embodiment has been described above, the present disclosure is not to be construed as being limited to the embodiment of the description, and can be applied to various embodiments within the scope not departing from the gist of the present disclosure.

In a modification, the dedicated computer configuring the assistance device 1a and/or the control system 3 of the assistance system 1 may have at least one of a digital circuit and an analog circuit as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In the modification, the constraint imposed by the monitoring block 340 may not be imposed on at least the actual trajectory Ta. In the modification, at least one of the set of S113 and S114 and the set of S115 and S116 does not need to be executed. In the modification, at least one of the set of S111 and S112 and the set of S115 and S116 does not need to be executed.

Here, the process of the flowchart or the flowchart described in this application includes a plurality of sections (or steps), and each section is expressed as, for example, S100. Further, each section may be divided into several subsections, while several sections may be combined into one section. Furthermore, each section thus configured may be referred to as a device, module, or means.

What is claimed is:

1. A remote assistance system for remotely assisting automated driving of a mobile object, the system comprising:
a processor; and
a memory coupled to the processor and storing program instructions that when executed by the processor cause the processor to at least:
acquire an assistance request that is a request from the mobile object;
generate instruction information according to an instruction from an operator in response to the assistance request;
transmit the instruction information to the mobile object;
collect determination information representing determination of the mobile object on the instruction information; and
output, as a transition timing of a dynamic driving task by the mobile object, evaluation information that has evaluated the operator based on a time gap between an instruction timing represented by the instruction information and a determination timing represented by the determination information.

2. The remote assistance system according to claim 1, wherein
the processor is configured to
collect plan information representing a plan provided by the mobile object according to the instruction information, and
collect behavior information that appears in the mobile object after the plan according to the instruction information,
wherein
outputting the evaluation information includes outputting the evaluation information based on a trajectory gap between a plan trajectory represented by the plan information and an actual trajectory represented by the behavior information, and
the plan trajectory and the actual trajectory are a traveling trajectory of the mobile object.

3. A remote assistance system for remotely assisting automated driving of a mobile object, the system comprising:
a processor; and
a memory coupled to the processor and storing program instructions that when executed by the processor cause the processor to at least:
acquire an assistance request that is a request from the mobile object;
generate instruction information according to an instruction from an operator in response to the assistance request;
transmit the instruction information to the mobile object;
collect plan information representing a plan provided by the mobile object according to the instruction information;
collect behavior information that appears in the mobile object after the plan according to the instruction information; and
output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.

4. The remote assistance system according to claim 2, wherein
collecting the behavior information includes collecting the behavior information representing the actual trajectory on which the mobile object imposes a constraint for the plan information.

5. The remote assistance system according to claim 2, wherein
outputting the evaluation information includes outputting the evaluation information based on an actual behavior of the mobile object and a statistical behavior represented by statistical information accumulated regarding the actual behavior, the actual behavior being represented by the behavior information.

6. The remote assistance system according to claim 1, wherein
generating the instruction information includes generating the instruction information that is an instruction from the operator via remote operation of the mobile object.

7. A remote assistance method for remotely assisting automated driving of a mobile object, the method causing a processor to:
acquire an assistance request that is a request from the mobile object;
generate instruction information according to an instruction from an operator in response to the assistance request;
transmit the instruction information to the mobile object;
collect determination information representing determination of the mobile object on the instruction information; and
output, as a transition timing of a dynamic driving task by the mobile object, evaluation information that has evaluated the operator based on a time gap between an instruction timing represented by the instruction information and a determination timing represented by the determination information.

8. A remote assistance method for remotely assisting automated driving of a mobile object, the method causing a processor to:
acquire an assistance request that is a request from the mobile object;
generate instruction information according to an instruction from an operator in response to the assistance request;
transmit the instruction information to the mobile object;
collect plan information representing a plan provided by the mobile object according to the instruction information;
collect behavior information that appears in the mobile object after the plan according to the instruction information; and
output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.

9. A non-transitory computer-readable storage medium storing a remote assistance program for remotely assisting automated driving of a mobile object, the program including instructions causing a processor to:
acquire an assistance request that is a request from the mobile object;
generate instruction information according to an instruction from an operator in response to the assistance request;
transmit the instruction information to the mobile object;
collect determination information representing determination of the mobile object on the instruction information; and
output, as a transition timing of a dynamic driving task by the mobile object, evaluation information that has evaluated the operator based on a time gap between an instruction timing represented by the instruction information and a determination timing represented by the determination information.

10. A non-transitory computer-readable storage medium storing a remote assistance program for remotely assisting automated driving of a mobile object, the program including instructions causing a processor to:
acquire an assistance request that is a request from the mobile object;
generate instruction information according to an instruction from an operator in response to the assistance request;
transmit the instruction information to the mobile object;
collect plan information representing a plan provided by the mobile object according to the instruction information;
collect behavior information that appears in the mobile object after the plan according to the instruction information; and
output evaluation information that has evaluated the operator based on a trajectory gap between a plan trajectory represented by the plan information and an actual trajectory represented by the behavior information, wherein the plan trajectory and the actual trajectory are a traveling trajectory of the mobile object.
